(19) United States
(12) Patent Application Publication
(10) Pub. No.: US 2019/0289128 A1
(43) Pub. Date: Sep. 19, 2019

(54) METHOD AND ELECTRONIC DEVICE FOR ENABLING CONTEXTUAL INTERACTION

(71) Applicant: Samsung Electronics Co., Ltd., Suwon-si (KR)

(72) Inventors: Anshumali BARUAH, Guwahati (IN); Poshith UDAYASHANKAR, Bangalore (IN); Varun PRABHAKAR, Pune (IN)

(21) Appl. No.: 16/284,321

(22) Filed: Feb. 25, 2019

(30) Foreign Application Priority Data
Mar. 15, 2018 (IN) 201841009451

(51) Int. Cl. H04M 1/725; G06F 9/451

(52) U.S. Cl. CPC H04M 1/72586; G06F 9/451; H04M 1/72566; H04M 1/72569

(57) ABSTRACT

A method for enabling contextual interaction on an electronic device is provided. The method includes detecting a context indicative of user activities associated with the electronic device and identifying one or more functions from a pre-defined set of functions based on the detected context. Further, the method also includes causing to display the one or more functions, where the one or more functions are capable of executing at least one of applications or services for accessing content relevant to the context, and dynamically performing an action relevant to the context in response to an interaction with a function.

### CROSS-REFERENCE TO RELATED APPLICATION(S)

This application is based on and claims priority under 35 U.S.C. § 119(a) to Indian patent application number 201841009451, filed on Mar. 15, 2018, in the Indian Intellectual Property Office, the disclosure of which is incorporated by reference herein in its entirety.

### BACKGROUND

### 1. Field

The disclosure relates to electronic devices. More particularly, the disclosure relates to a method and electronic device for enabling contextual interaction.

### 2. Description of the Related Art

In general, electronic devices are ubiquitous in all aspects of modern life. Over a period of time, the manner in which the electronic devices display information on a user interface has become intelligent, efficient, spontaneous, and less obtrusive. The users interact on the user interfaces to navigate and to direct functionality to the electronic device. However, the user interface of the electronic device is mostly static i.e., the user interfaces are not customized based on any parameter such as context, conditions, etc. of the user and display a pre-defined set of applications. Further, the static user interfaces might cause inconvenience to the user in accessing the electronic device due to the increased number of steps involved to access a feature in the electronic device.

In an example, consider that the user is driving. The user interface (UI) of the electronic device is a home screen containing date, time and the applications that the user has selected to be displayed on the home screen, which are all static. When the user wants to play some preferred music, the user will have to navigate through the electronic device to access a music application to play the preferred music. Further, if the user wants to switch to a radio player, then the user will have to repeat the above mentioned steps. Furthermore, if the user wants to make a payment at a toll booth then the user will again have to browse through the applications to find a payment application and make the payment.

Further, the user may have to manually change settings of the electronic device to change the applications appearing on the user interface of the electronic device, which are both inconvenient and time-consuming.

The above information is presented as background information only to help the reader to understand the disclosure. Applicants have made no determination and make no assertion as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and device for enabling contextual interaction.

Another aspect of the disclosure is to automatically determine a context of a user and to display functions based on the context on the screen of the electronic device.

Another aspect of the disclosure is to identify one or more functions from a pre-defined set of functions based on the detected context.

Another aspect of the disclosure is to identify one or more functions from a pre-defined set of functions and present the functions for user interaction.

Another aspect of the disclosure is to display the one or more functions distinctively based on the detected context for user interaction.

Another aspect of the present disclosure is to provide a method to determine the context of the user based on at least one of digital context associated with the user, physical context associated with the user, or user persona including usage pattern and a behavioral pattern of the user.

Additional aspects will be set forth in part in the description which follows and, in part, will be apparent from the description, or may be learned by practice of the presented embodiments.

In accordance with an aspect of the disclosure, a method for enabling contextual interaction on an electronic device is provided. The method includes detecting a context indicative of user activities associated with the electronic device and identifying one or more functions from a pre-defined set of functions based on the detected context. Further, the method also includes causing to display the one or more functions, where the one or more functions are capable of executing at least one of applications or services for accessing content relevant to the context, and dynamically performing an action relevant to the context in response to an interaction with a function.

In accordance with another aspect of the disclosure, an electronic device for enabling contextual interaction is provided. The electronic device includes a memory, a processor, a context detection engine, a function identification module and an output component. The context detection engine is configured to detect a context indicative of user activities associated with the electronic device. The function identification module is configured to identify one or more functions from a pre-defined set of functions based on the detected context. The output component is configured to cause to display the one or more functions, wherein the one or more functions are capable of executing at least one of applications or services for accessing content relevant to the context and dynamically perform an action relevant to the context in response to an interaction with a function.

Accordingly, an aspect of the disclosure is to provide a method for enabling interaction on an electronic device. The method includes identifying one or more functions from a pre-defined set of functions in the electronic device and causing to display the one or more functions, where the one or more functions are capable of executing at least one of applications or services for accessing content. Further, the method also includes dynamically performing an action in response to an interaction with a function.

Accordingly, an aspect of the disclosure is to provide an electronic device for enabling interaction. The electronic device includes a memory, a processor, a function identification module and an output component. The function identification module is configured to identify one or more functions from a pre-defined set of functions in the electronic device. The output component is configured to cause to display the one or more functions, wherein the one or more functions are capable of executing at least one of applications or services for accessing content and dynamically perform an action in response to an interaction with a function.

These and other aspects of the disclosure will be better appreciated and understood when considered in conjunction with the following description and the accompanying drawings. It should be understood, however, that the following descriptions, while indicating various embodiments and numerous specific details thereof, are given by way of illustration and not of limitation. Many changes and modifications may be made within the scope of the disclosure without departing from the spirit thereof, and the embodiments herein include all such modifications.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a block diagram illustrating various hardware elements of an electronic device for enabling contextual interaction, according to an embodiment of the disclosure;

FIG. 2 illustrates examples of functions associated to the context of the user, according to an embodiment of the disclosure;

FIG. 3 illustrates examples of functions along with the associated relevant functions, according to an embodiment of the disclosure;

FIG. 4 is a flow chart illustrating a method for enabling contextual interaction with the electronic device, according to an embodiment of the disclosure;

FIG. 5 is a flow chart illustrating a method of function detection and performing an action based on a response selected by the user, according to an embodiment of the disclosure;

FIGS. 6A and 6B is an example scenario illustrating the method for providing functions on a screen of the electronic device based on the context of the user, according to an embodiment of the disclosure;

FIGS. 7A and 7B is an example scenario illustrating the method for providing functions on the screen of the electronic device based on application notifications, according to an embodiment of the disclosure;

FIGS. 8A, 8B, and 8C is an example scenario illustrating the method of invoking the functions based on a location of the user on the screen of the electronic device, according to an embodiment of the disclosure;

FIGS. 9A, 9B, and 9C is an example scenario illustrating the method of invoking the functions based on a time of a day on the screen of the electronic device, according to an embodiment of the disclosure;

FIGS. 10A, 10B, 10C, and 10D is an example scenario illustrating the method of providing the functions on the user interface of a virtual assistant based on the application notifications and suggestions provided by the virtual assistant, according to an embodiment of the disclosure; and

FIGS. 11A, 11B, and 11C is an example scenario illustrating the method of invoking the functions based on frequently used applications on the screen of the electronic device, according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art that various changes and modifications of the embodiments described herein can be made without departing from the scope and spirit of the disclosure. In addition, descriptions of well-known functions and constructions are omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Also, the various embodiments described herein are not necessarily mutually exclusive, as some embodiments can be combined with one or more other embodiments to form new embodiments.

Herein, the term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as units, engines, manager, modules or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and/or software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Accordingly, the embodiments herein provide a method for enabling contextual interaction on an electronic device. The method includes detecting a context indicative of user activities associated with the electronic device and identifying one or more functions from a pre-defined set of functions based on the detected context. Further, the method also includes causing to display the one or more functions, where the one or more functions are capable of executing at least one of applications or services for accessing content relevant to the context; and dynamically performing an action relevant to the context in response to an interaction with a function.

In an embodiment, the one or functions are identified based on at least one of digital context associated with the user, physical context associated with the user, or user persona including usage pattern and a behavioral pattern of the user.

In an embodiment, each of the function comprises a plurality of relevant functions associated with the function.

In an embodiment, dynamically performing the action relevant to the context in response to the interaction with the function includes determining a plurality of relevant functions associated with the function. Further, the method also includes identifying a relevant function from the plurality of relevant functions using the detected context and performing the action based on the determined relevant function selected by the user.

In an embodiment, the plurality of relevant functions associated with the function is displayed along with the function for user interaction.

In an embodiment, the one or more functions are displayed distinctively based on the detected context for user interaction.

In an embodiment, the one or more functions are displayed automatically via a screen of the electronic device based on the detected context.

In an embodiment, the one or more functions are displayed via the screen of the electronic device for the detected context based on an input received from the user, wherein the input is one of a gesture input or a voice input.

In an embodiment, the one or more functions and the plurality of relevant functions for the one or more functions are displayed on a pre-defined portion via the screen of the electronic device.

Related-art methods and systems provide user interfaces (UIs) that are static i.e., the UI is not customized based on context of the user. In an example, the related-art UI of the electronic devices do not change based on whether the user is at home or driving.

Unlike related-art methods and systems, the proposed method allows the electronic device to determine the context of the user and provide the list of relevant functions based on the determined context, via a screen of the electronic device.

Unlike related-art methods and systems, the proposed method allows the electronic device to provide the relevant functions distinctively via a screen of the electronic device i.e., by highlighting the functions, enlarging the size of the relevant functions as compared to the other functions and the like.

Unlike related-art methods and systems, the proposed method links the notifications received from various applications to the context of the user and provide the list of relevant functions via a screen of the electronic device 100.

Related-art methods and systems are application based where the user has to follow a pre-defined path to access content on the electronic device which makes the process time consuming. Unlike related-art methods and systems, the proposed method is function based wherein the functions provide an easy access to a group of applications which are utilized for a specific purpose i.e., a function “play” may include all the applications like an audio player, a video player, radio, podcasts etc. combined into one function.

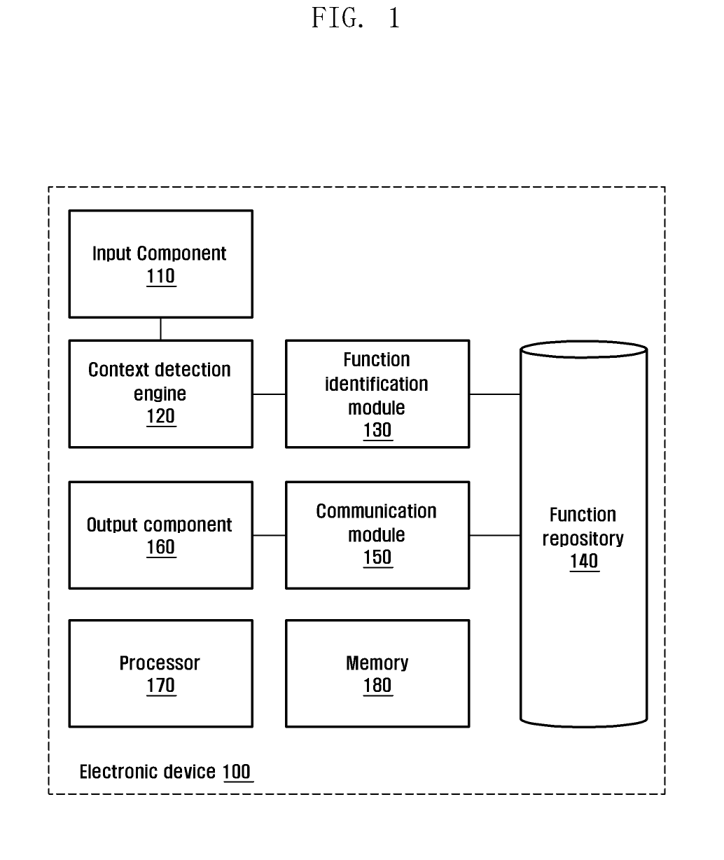

Referring now to the drawings, and more particularly to FIGS. 1 through 10, where similar reference characters denote corresponding features consistently throughout the figures, there are shown preferred embodiments.

FIG. 1 is a block diagram illustrating various hardware elements of the electronic device 100 for enabling contextual interaction, according to an embodiment of the disclosure.

In an embodiment, the electronic device 100 can be a mobile phone, a smart phone, personal digital assistants (PDAs), a tablet, a wearable device, a display device, an internet of things (IoT) device, electronic circuit, chipset, and electrical circuit (i.e., system on chip (SoC)), etc.

Referring to the FIG. 1, the electronic device 100 includes an input component 110, a context detection engine 120, a function identification module 130, a function repository 140, a communication module 150, an output component 160, a processor 170 and a memory 180. In various embodiments, the function repository 140 can be implemented on the memory 180. In various embodiments, the context detection engine 120 or the function identification module 130 can be implemented in the processor 170.

In an embodiment, the input component 110 can be configured to receive the input from the user on the screen of the electronic device 100. The input from the user can be one of gesture (e.g., touch, tap, drag, swipe, pressing of a dedicated button etc.), voice and the like. The set of functions associated with the context of the user is invoked by the user by providing the input on the UI of the electronic device 100. The UI can also be a voice input interface associated with a voice assistant application. The input component 110 can be hardware capable of receiving the user input. For example, the input component 110 can be a display or a microphone.

In an embodiment, the context detection engine 120 can be configured to determine the user context. The context indicates user activity and/or user intention. The context defines the activity of the user associated with the electronic device 100. The context can be one of a physical context or a digital context. The physical context can be determined based on one of the current location of the user (e.g., shopping mall, theatre, restaurant, etc.), time of the day (e.g., morning, afternoon, evening, night) and the activity performed by the user (for example walking, jogging, driving, sitting, etc.). The digital context can be determined based on one of notifications, ongoing task of the user, upcoming activities, status of connected device(s), browsing history (e.g., the user has searched for finance related sites, etc.), frequently used application, kind of profile used by the user (i.e., work profile, home profile) s and the like. The context detection engine 120 can be determine user context by using a plurality of sensors. For example, the plurality of sensors can be GPS sensor module, proximity sensor, acceleration sensor module, a gyro sensor, a gesture sensor, a grip sensor, color sensor or infrared sensor.

For example, when user is driving, the electronic device 100 automatically detects the context of the user based on the activity performed by the user i.e., driving and identifies the functions related to driving. Further, the electronic device 100 displays the functions and the associated sub-functions on the screen of the electronic device 100.

In an embodiment, the function identification module 130 can be configured to identify the functions based on the context of the user. The function can mean a function executable in at least one application installed in the electronic device 100. If the application installed in the electronic device 100 is modified, the function can also be modified. Initially, the function identification module 130 determines whether the function identification module 130 has access to the digital persona of the user. On determining that the function identification module 130 has access to the digital persona of the user, the function identification module 130 uses the digital persona of the user to determine the function based on the digital context of the user. The digital persona of the user is developed by the electronic device 100 based on a continuous learning of the user's behavior. Further, to access the digital persona of the user, the function repository 140 is assumed to be located outside the electronic device 100 (e.g., a cloud server) and accessed with wireless communication techniques through the communication module 150.

On determining that the function identification module 130 does not have access to the digital persona of the user (i.e., the function repository 140 is offline), the function identification module 130 uses only the physical context and the usage pattern analysis of the user to determine the functions. Further, the function identification module 130 filters the functions and prioritizes the functions based on the usage pattern analysis of the user.

In an embodiment, the function repository 140 can be configured to store the list of functions associated with the physical context and the digital context identified by the function identification module 130. Further, the function repository 140 also stores the digital persona of the user which is created based on learning the usage pattern of the user. Further, the function repository 140 can be embedded within the electronic device 100 and readily accessed. In another embodiment, the function repository 140 can be located outside the electronic device 100 (e.g., a cloud server) and accessed using wireless communication techniques through the communication module 150.

In an embodiment, the communication module 150 can be configured to communicate with the function repository 140. Further, the communication module 150 determines whether the function repository 140 is online and implements one or more suitable protocols for communication. The protocols for communication can be for example, Bluetooth, near field communication (NFC), ZigBee, RuBee, and wireless local area network (WLAN) functions, etc.

In an embodiment, the output component 160 can be configured to provide one or more functions on the screen of the electronic device 100. The functions are fetched and displayed automatically on the screen of the electronic device 100 based on the detected context. The one or more functions are capable of executing at least one of applications or services for accessing the content relevant to the context. Further, the output component 160 is configured to display the one or more functions distinctively on the screen of the electronic device 100 based on the detected context. For example, the functions which have received notifications from the associated applications are highlighted and presented on the screen of the electronic device 100. In various embodiments, the output component 160 can be implemented on the display.

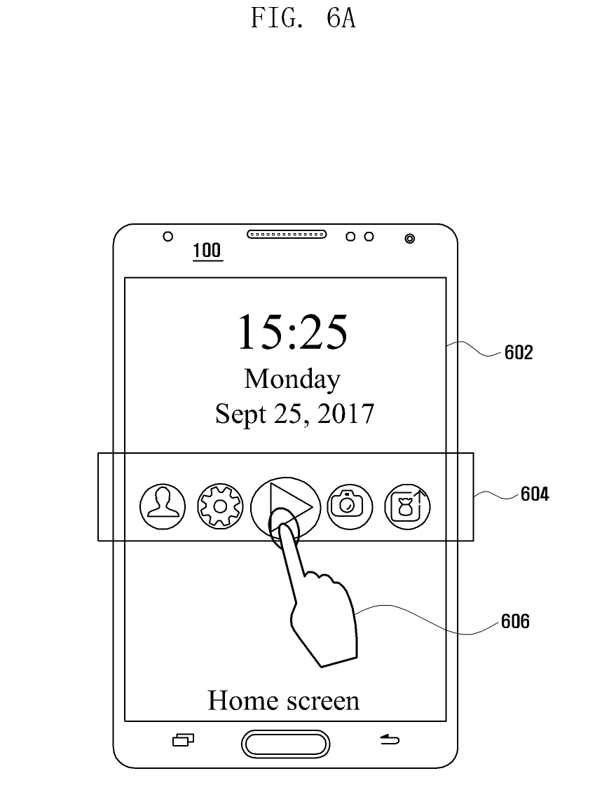

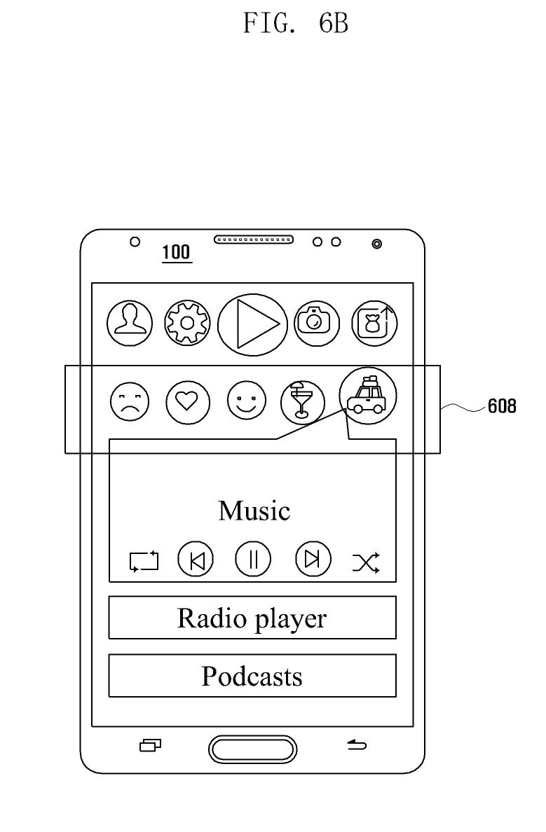

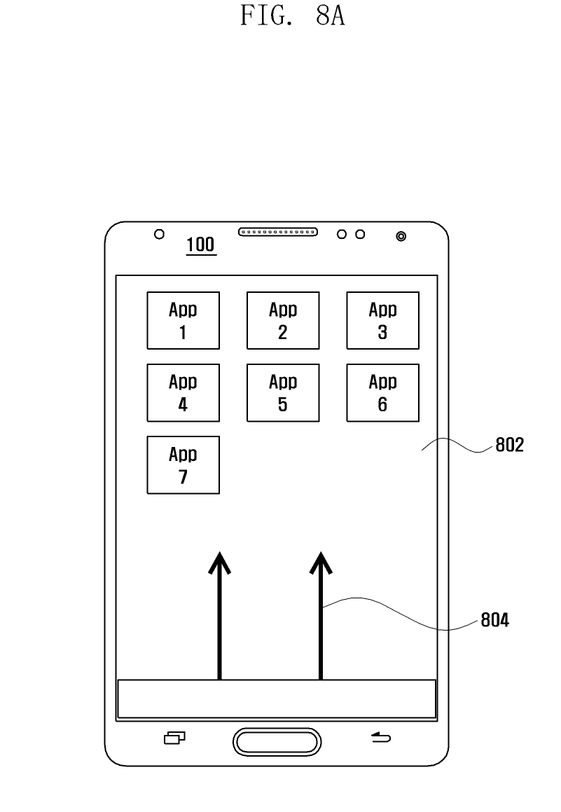

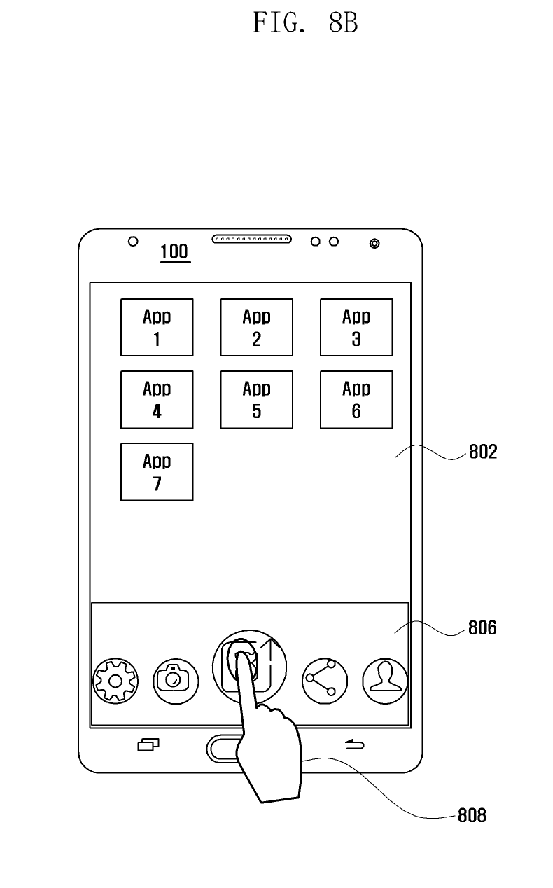

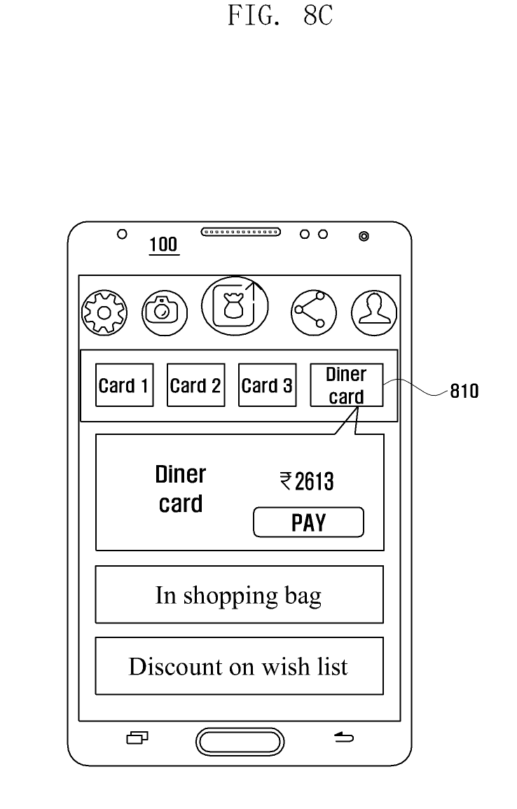

Further, the output component 160 is configured to dynamically perform one or more actions relevant to the context in response to the interaction by the user, with a function i.e., the output component 160 initiates the action to be performed based on the function selected by the user. Furthermore, the one or more functions and the plurality of relevant functions associated with the one or more functions are displayed on a pre-defined portion on the screen of the electronic device 100. For example, the user invokes the list of functions by performing a gesture on the bottom portion of the screen of the electronic device 100 and the list of functions are displayed in the bottom portion of the screen of the electronic device 100 (as illustrated in FIGS. 8A-8C). In another example, the list of functions can be presented on the locked home screen of the electronic device 100 (as illustrated in FIGS. 6A-6B).

In an embodiment, the processor 170 can be configured to interact with the hardware elements such as the input component 110, the context detection engine 120, the function identification module 130, the function repository 140, the communication module 150, the output component 160 and the memory 180 for providing the UI of the electronic device 100.

In an embodiment, the memory 180 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 180 may, in some examples, be considered a non-transitory storage medium. The term “non-transitory” may indicate that the storage medium is not embodied in a carrier wave or a propagated signal. However, the term “non-transitory” should not be interpreted that the memory 180 is non-movable. In some examples, the memory 180 can be configured to store larger amounts of information than the memory. In certain examples, a non-transitory storage medium may store data that can, over time, change (e.g., in random access memory (RAM) or cache).

Although the FIG. 1 shows the hardware components of the electronic device 100 but it is to be understood that other embodiments are not limited thereon. In other embodiments, the electronic device 100 may include less or a greater number of components. Further, the labels or names of the components are used only for illustrative purpose and does not limit the scope of the disclosure. One or more components can be combined together to perform same or substantially similar function to enable contextual interaction on the electronic device 100.

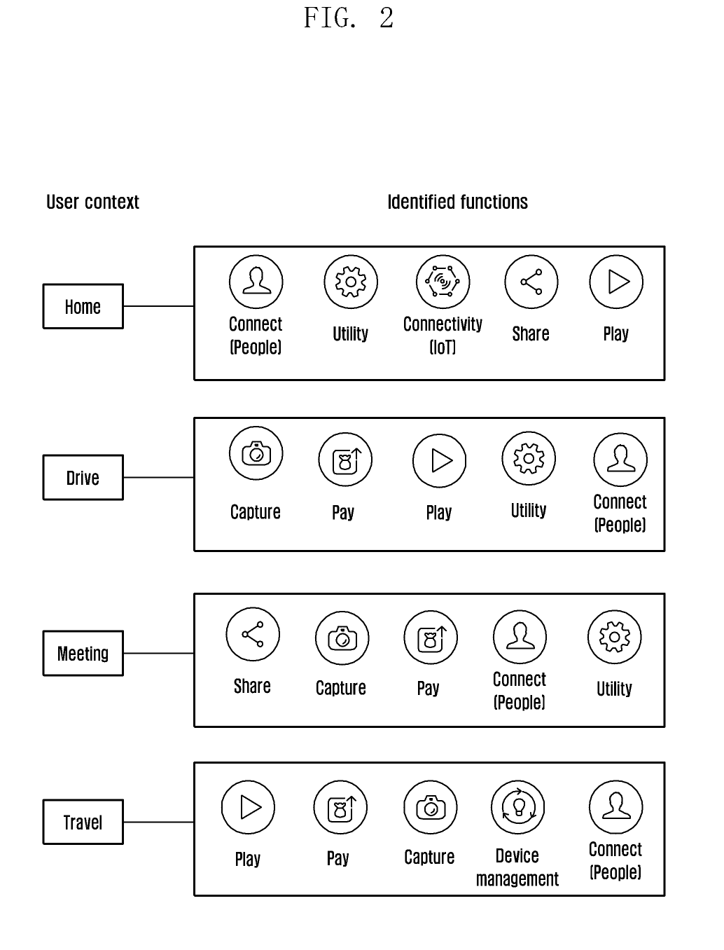

FIG. 2 illustrates examples of functions associated to the context of the user, according to an embodiment of the disclosure.

Referring to FIG. 2, the relevant functions are determined from the plurality of functions, based on at least one of digital context associated with the user, physical context associated with the user, or user persona including usage pattern and a behavioral pattern of the user.

In various embodiments, the context detection engine 120 can identify the user context or context of the electronic device 100. For example, the context detection engine 120 can identify the user context including the location of the user by using the GPS sensor. The context detection engine 120 can identify the user context including the velocity of the user by using the acceleration sensor. The context detection engine 120 can identify the context of the electronic device 100. The context of the electronic device 100 can include a capability, performance, or status of the electronic device 100.

In an example, consider that the user is at home. Based on the location of the user (i.e., the physical context of the user), the context detection engine 120 determines the context as ‘home’. The function identification module 130 identifies the relevant functions associated with ‘home’ based on the digital persona of the user, the context of the user and the usage pattern analysis of the user. Further, the relevant functions are populated on the screen of the electronic device 100. One of the relevant functions can be ‘connect function’. The sub-functions associated with the connect function can be contacts, text messaging applications, instant messaging applications and the like. The ‘connect function’ enable the user to automatically send a text message to a frequently messaged contact etc. Other relevant functions are ‘utility function’ which would enable the user to access reminders, the ‘connectivity IoT function’ which would enable the user to control the connected devices, the ‘share function’ which would enable the user to share multimedia or location data with the contacts, the ‘play function’ which would enable the user to play multimedia content such as videos, music etc.

In various embodiments, the context detection engine 120 can identify the context of user by using the plurality of sensors. In response to identifying the context of user, the context detection engine 120 can transmit the identified context to the function identification module 130.

In various embodiments, the related functions can be grouped according to index of the context. The processor 170 can identify the application installed in the electronic device 100 and the function being provided by the application every predetermined period. The processor 170 can group the identified functions based on the context, and store the grouped functions in the function repository 140. The information of the related function can be stored in the function repository 140.

In various embodiments, the function identification module 130 can identify the related functions corresponding to the identified context. For example, the function identification module 130 can request the function repository 140 to transmit the related functions corresponding to the identified functions. The function identification module 130 can control the output component 160 to provide at least one of the related functions on the display of the electronic device 100.

In various embodiments, the output component 160 can receive information of the related functions from the function identification module. The output component 160 can configure a plurality of GUI (for example, icon) and display the plurality of GUI on the display of the electronic device 100. Each of the plurality of GUI corresponds to each of the related function.

In various embodiments, the processor 170 can receive the user input for requesting execution of the related function and display at least one icon corresponding to application providing the related function. The processor 170 can recommend or suggest the application based on the context information or a priority information of the application when the processor 170 identifies that a plurality of applications supporting the related function are installed in the electronic device. The processor 170 can identify at least one application among application installed in the electronic device 100 based on at least one of user activity, capability or status of the electronic device 100. For example, the processor 170 can identify application capable of executing a function corresponding to the selected object. The processor 170 can recommend or suggest the identified application. The processor 170 can execute the function in the selected application by executing the identified application.

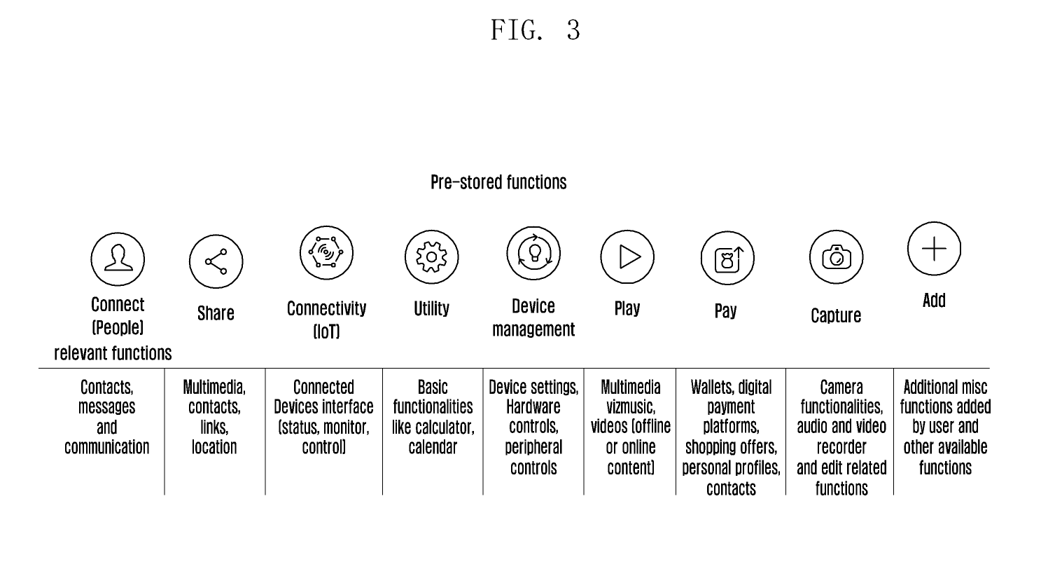

FIG. 3 illustrates examples of functions along with the associated relevant functions, according to an embodiment of the disclosure.

Referring to FIG. 3, the functions are determined based on the context of the user of the electronic device 100. Further, the notifications are also taken into consideration to determine the functions associated with the context of the user. Referring to the FIG. 3, the list of functions are provided, which can be associated to the user context. The list of functions can be generated by the processor 170. The processor 170 can identify the application installed in the electronic device 100 and the function being provided by the application. Further, each function has sub-functions associated to the functions as described in Table 1.

TABLE 1

| | |
|---|---|
| Functions | Sub-functions associated with the |
| | functions |
| Connect (People) | Contacts, messages and |
| | communication applications, IM, |
| | email applications, SNS |
| | applications |
| Share | Multimedia applications, contacts, |
| | links, location applications |
| Connectivity (IoT) | Connected devices interface |
| | (status, monitor, control) |
| Utility | Basic functionalities like |
| | calculator, |
| | Calendar, reminder, etc. |
| Device management | Device settings, hardware controls, |
| | peripheral controls etc. |
| Play | Multimedia applications i.e., |
| | music, |
| | videos (offline or online content) |
| Pay | Wallets, digital payment |
| | platforms, shopping offers, |
| | personal profiles, contacts |
| Capture | Camera functionalities, audio and |
| | video recorder and edit related |
| | functions |
| Add | Additional miscellaneous |
| | functions added by the user and |
| | other available functions |

The notifications related to the functions are described in Table 2.

TABLE 2

| | |
|---|---|
| Functions | Notifications associated with the |
| | functions |
| Connect (People) | Missed call, reply, call back, etc. |
| Share | If there are content based notifications, |
| | content is curated and ready to be shared |
| | by the user |
| Connectivity | When task of any connected device is |
| (IoT) | about to get over, devices are available |
| | for connection |
| Utility | Alarm, reminder, upcoming events, etc. |
| Device | Battery low, memory low, data low, etc. |
| management | |
| Play | Any multimedia related notification, a |
| | shared a picture, video, etc. |
| Pay | Payment related notifications such as |
| | expense tracking, bill payment etc. |
| Capture | Edit suggestions, create and backup |
| | content, suggest new add-ons, suggest |
| | new features available, etc. |

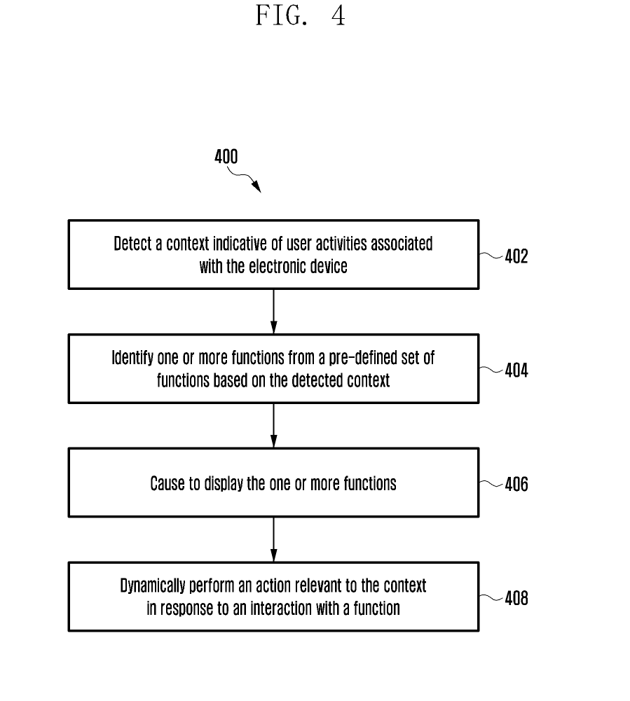

FIG. 4 is a flow chart 400 illustrating a method for enabling contextual interaction with the electronic device 100, according to an embodiment of the disclosure.

Referring to the FIG. 4, at operation 402 the electronic device 100 detects a context indicative of user activities associated with the electronic device 100. For example, in the electronic device 100 as illustrated in the FIG. 1, the context detection engine 120 can be configured to detect a context indicative of user activities associated with the electronic device 100.

At operation 404, the electronic device 100 identifies one or more functions from a pre-defined set of functions based on the detected context. For example, in the electronic device 100 as illustrated in the FIG. 1, the Function identification module 130 can be configured to identify one or more functions from a pre-defined set of functions based on the detected context.

At operation 406 the electronic device 100 causes to display the one or more functions. For example, in the electronic device 100 as illustrated in the FIG. 1, the output component 160 can be configured to cause to display the one or more functions.

At operation 408 the electronic device 100 dynamically performs the action relevant to the context in response to an interaction with a function. For example, in the electronic device 100 as illustrated in the FIG. 1, the output component 160 can be configured to dynamically perform the action relevant to the context in response to an interaction with a function.

The various actions, acts, blocks, steps, or the like in the method may be performed in the order presented, in a different order or simultaneously. Further, in some embodiments, some of the actions, acts, blocks, steps, or the like may be omitted, added, modified, skipped, or the like without departing from the scope of the disclosure.

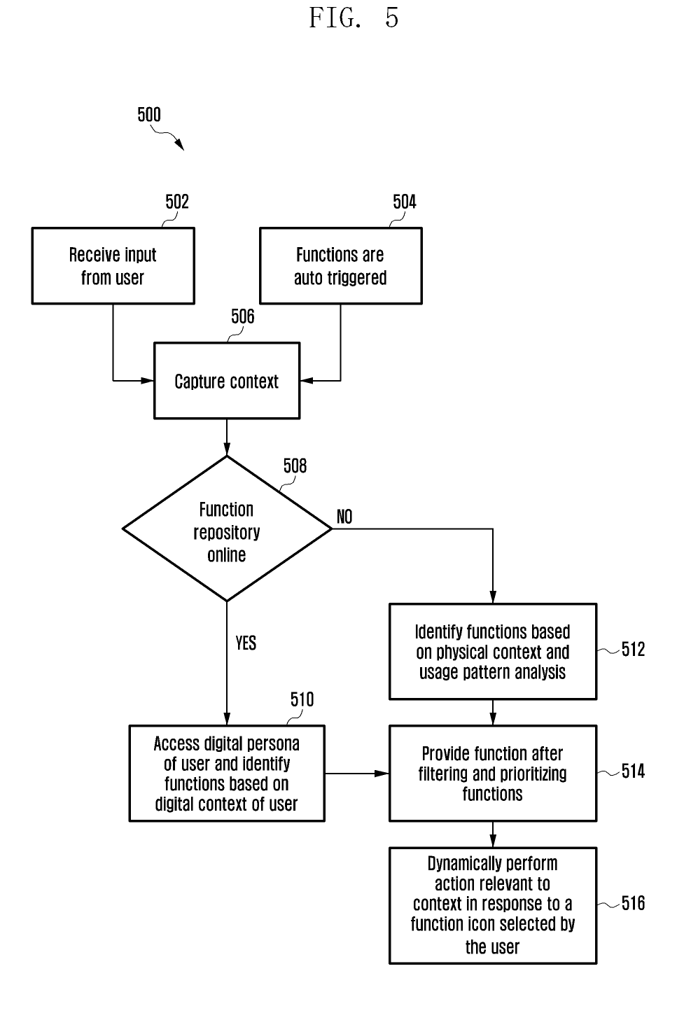

FIG. 5 is a flow chart 500 illustrating a method of function detection and performing an action based on a response selected by the user, according to an embodiment of the disclosure.

Referring to the FIG. 5, at operation 502, the electronic device 100 can receive the input from the user. In another embodiment, the electronic device 100 at operation 504 can automatically invoke the functions. For example, in the electronic device 100 as illustrated in the FIG. 1, the input component 110 can be configured to receive the input from the user.

At operation 506, the electronic device 100 captures the context of the user. For example, in the electronic device 100 as illustrated in the FIG. 1, the context detection engine 120 can be configured to capture the context of the user.

At operation 508, the electronic device 100 determines whether the function repository 140 is online i.e., whether the function repository 140 has access to the digital persona of the user. For example, in the electronic device 100 as illustrated in the FIG. 1, the function identification module 130 can be configured to determine whether the function repository 140 is online i.e., whether the function repository 140 has access to the digital persona of the user.

On determining that the function repository 140 does not has access to the digital persona of the user, at operation 512, the electronic device 100 identifies the relevant functions based on the physical context and the usage pattern analysis of the user. For example, in the electronic device 100 as illustrated in the FIG. 1, the function identification module 130 can be configured to identify the relevant functions based on the physical context and the usage pattern analysis of the user.

At operation 514, the electronic device 100 provides the functions after filtering and prioritizing the functions. For example, in the electronic device 100 as illustrated in the FIG. 1, the output component 160 can be configured to provide the functions after filtering and prioritizing the functions.

At operation 516, the electronic device 100 dynamically performs the action relevant to context, in response to the function selected by the user. For example, in the electronic device 100 as illustrated in the FIG. 1, the output component 160 can be configured to dynamically perform the action relevant to context, in response to the function selected by the user.

On determining that the function repository 140 is online i.e., the function repository 140 has access to the digital persona of the user, at operation 510, the electronic device 100 accesses the digital persona of user and identifies the relevant functions based on the digital context of user. For example, in the electronic device 100 as illustrated in the FIG. 1, the function identification module 130 can be configured to accesses the digital persona of user and identify the relevant functions based on the digital context of user. Further, the electronic device 100 loops to operation 514.

The various actions, acts, blocks, steps, or the like in the method may be performed in the order presented, in a different order or simultaneously. Further, in some embodiments, some of the actions, acts, blocks, steps, or the like may be omitted, added, modified, skipped, or the like without departing from the scope of the disclosure.

FIGS. 6A and 6B is an example scenario illustrating the method for providing functions on the screen of the electronic device 100 based on the context of the user, according to an embodiment of the disclosure.

Referring to FIGS. 6A and 6B, a scenario that the user of the electronic device 100 is driving. The electronic device 100 determines the context of the user as driving. Further, the electronic device 100 fetches the set of functions 604 associated with driving and provides the set of functions 604 on the home screen 602 of the electronic device 100, as shown in FIG. 6A.

The functions associated with driving can be for example navigation applications, camera or video applications, payment applications, music applications, map applications, applications providing information pertaining to the surroundings, applications providing information pertaining to traffic, etc. Further, the user is allowed to select the required function from the set of functions 604 associated with driving which are presented on the home screen 602 of the electronic device 100.

The user performs a gesture 606 and selects the required function from the set of functions 604 i.e., the user selects the play music function. The electronic device 100 on receiving the gesture 606 electronic device 100 filters the sub-functions to be associated with the play music function based on the context of the user. Since the context of the user is determined to be driving, the electronic device 100 excludes video related sub-functions and associates only the audio related sub-functions to the play music function. Further, the electronic device 100 provides the relevant functions (i.e., sub-functions) associated with the play music function. The relevant functions associated with the play music function can be for example, play lists 608 such as happy songs play list, emotional songs play list, ambitious songs play list, travel songs play list etc., radio player, podcasts and the like. Further, the play list associated with driving is automatically selected from the set of play lists and played without the user having to select the play list, as shown in FIG. 6B. Further, the play list can be one of predetermined by the user, based on users' choices, behavior, popularity and the like. The play lists may be fetched from the local drive of the electronic device 100 or from some cloud server and the like. The play music function selected is executed with appropriate content from music applications, users' choices, behavior and popularity.

Further, the user is also provided with the option of selecting a different playlist or music application from the home screen 602 (e.g., select to play radio) in case the user wants to play music from some other playlist or application. The user can select a different playlist or application with voice command, touch command, etc.

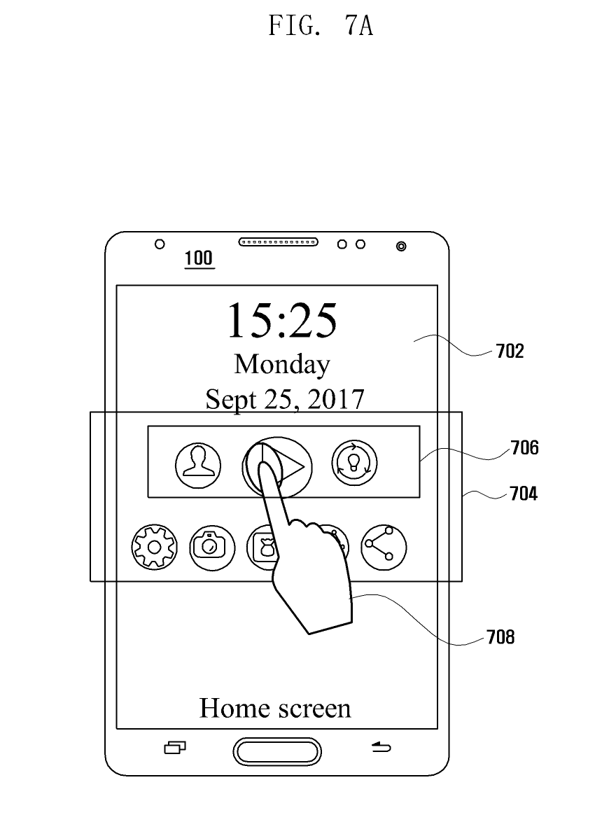

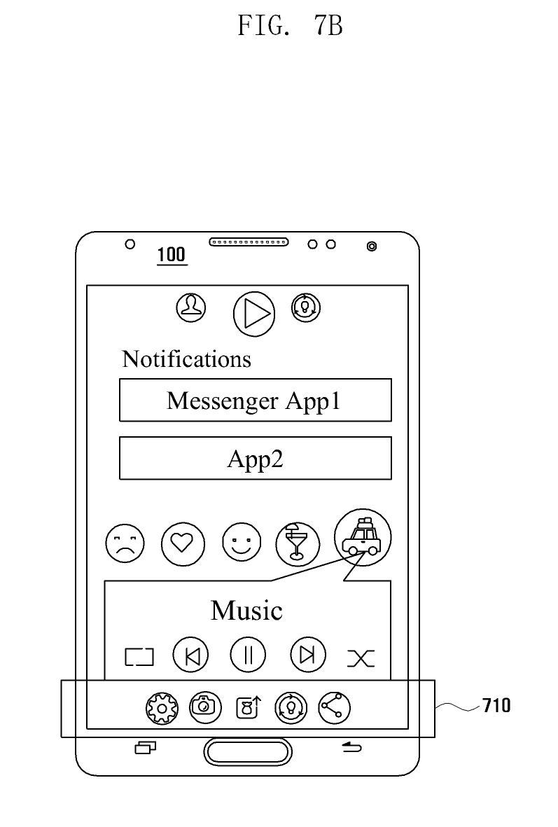

FIGS. 7A and 7B is an example scenario illustrating the method for providing functions on the screen of the electronic device 100 based on application notifications, according to an embodiment of the disclosure.

Referring to FIGS. 7A and 7B, a scenario that the user of the electronic device 100 is driving. Also consider that the electronic device 100 has received notifications associated with three applications i.e., messenger app1, music app2 and messenger app2. The electronic device 100 determines the context of the user as driving. Further, the electronic device 100 fetches the set of functions 704 associated with driving and provides the set of functions 704 on the home screen 702 of the electronic device 100, as shown in FIG. 7A. The set of functions 704 includes a set of highlighted functions 706 which are presented on the home screen 702 of the electronic device 100. The highlighted functions 706 are the functions which are associated with the applications which have recent updates or notifications i.e., functions associated with the messenger app1, the music app2 and the messenger app2. The messenger app1, and the messenger app2 may be associated with the connect function; and the music app2 may be associated with the play music function. Hence, the connect function and play music function are highlighted and presented on the home screen 702 of the electronic device 100, as shown in FIG. 7A.

The user selects the play music function from the set of functions 704 by performing the gesture 708 on the home screen 702 of the electronic device 100. On determining that the user has selected the play music function, the electronic device 100 automatically launches the music app2 and plays the received music file, as shown in FIG. 7B.

Further, the user is allowed to select any other sub-function other than the sub-function being played. Furthermore, if the user wants to access any other function apart from the highlighted functions, the electronic device 100 provides the set of functions 710 at the bottom of the screen of the electronic device 100, as shown in FIG. 7B.

FIGS. 8A, 8B, and 8C is an example scenario illustrating the method of invoking the functions based on a location of the user on the screen of the electronic device 100, according to an embodiment of the disclosure.

Referring to FIGS. 8A, 8B, and 8C, the functions can be invoked on the application menu screen 802 by using a gesture 804 once the electronic device 100 is unlocked, as shown in FIG. 8A.

Consider a scenario where the user of the electronic device 100 is dining at a restaurant. The user performs the gesture 804 to invoke the functions on the application menu screen 802. The electronic device 100 determines the context of the user based on the user location (i.e., restaurant) as dining. Further, the electronic device 100 provides the set of functions 806 associated with dining on the application menu screen 802 of the electronic device 100, as shown in FIG. 8B. The set of functions 806 associated with dining can be for example payment functions, shopping functions, photos, tips, recommendations, ratings, etc. Further, the user selects the payment function from the set of functions 806 provided on the screen of the electronic device 100, by performing the gesture 808.

As the user selects the payment function from the set of functions 806, the electronic device 100 automatically initiates the payment using a pre-saved diner card 810, as shown in FIG. 8C. Further, the user is allowed to select one of card 1, card 2 and card 3 to make the payment in case the user does not want to make payment using the diner card 810.

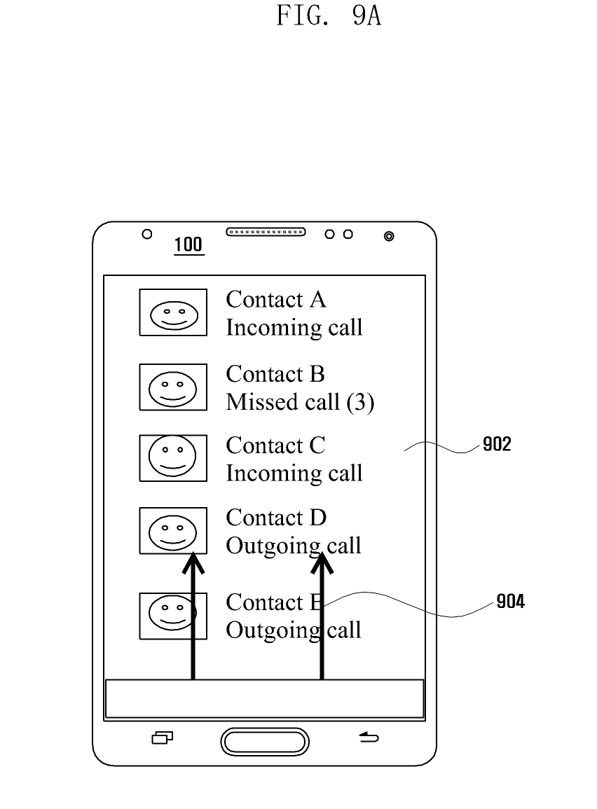

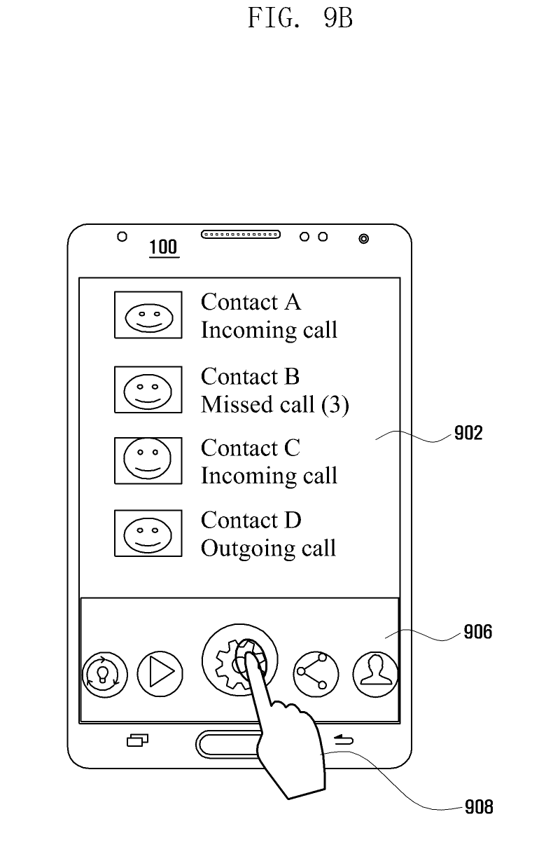

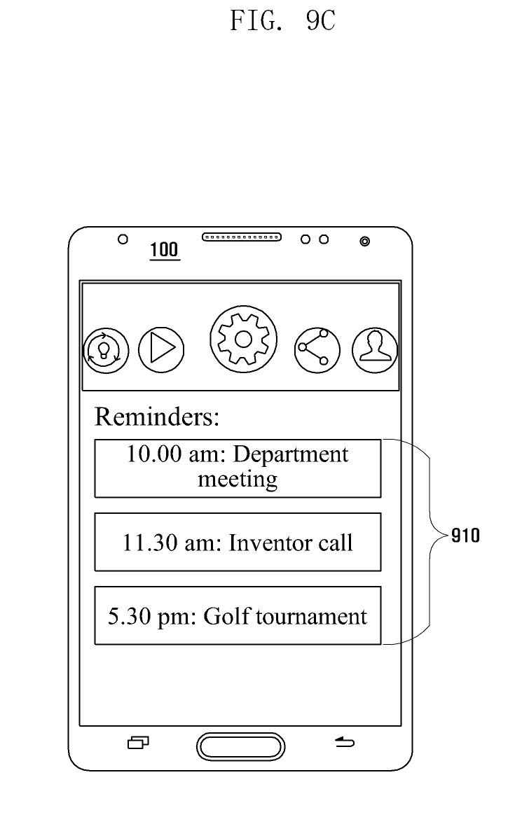

FIGS. 9A, 9B, and 9C is an example scenario illustrating the method of invoking the functions based on a time of a day on the screen of the electronic device 100, according to an embodiment of the disclosure.

Referring to 9A, 9B, and 9C, a scenario where the user checks the electronic device 100 in the early hours of the day i.e., morning. The user invokes the set of functions 906 associated with the context of the user on the existing UI of the contact screen 902 by performing a gesture 904, as shown in FIG. 9A. The electronic device 100 determines the context of the user based on the time of the day. Further, the electronic device 100 determines the relevant functions associated with the context of time of the day, based on the digital context and the physical context of the user. The electronic device 100 then provides the set of functions 906 associated with the time of the day at the bottom of the contact screen 902 of the electronic device 100, as shown in FIG. 9B. The functions associated with the time of the day (i.e., during morning time) can be for example contacts, play some devotional music, device management, utility like, share some media, reminders for the day, applications that are used frequently by that user such as applications to know weather, news headlines, etc. in the morning time. Further, the user selects the utility function from the set of functions 906 by performing the gesture 908 on the existing UI. The electronic device 100 automatically provides the relevant functions associated with the utility function such as a list of reminders 910 scheduled for the entire day, as shown in FIG. 9C.

Further, if the user regularly accesses the New York Times application in the morning, then the electronic device 100 learns the user behavior pattern and adds the New York Times application to the play function. The user can launch the New York Times application by selecting the play function.

Further, the set of functions 906 associated with the time of the day is provided on the screen of the electronic device 100 and the user can select any of the functions to access a different application.

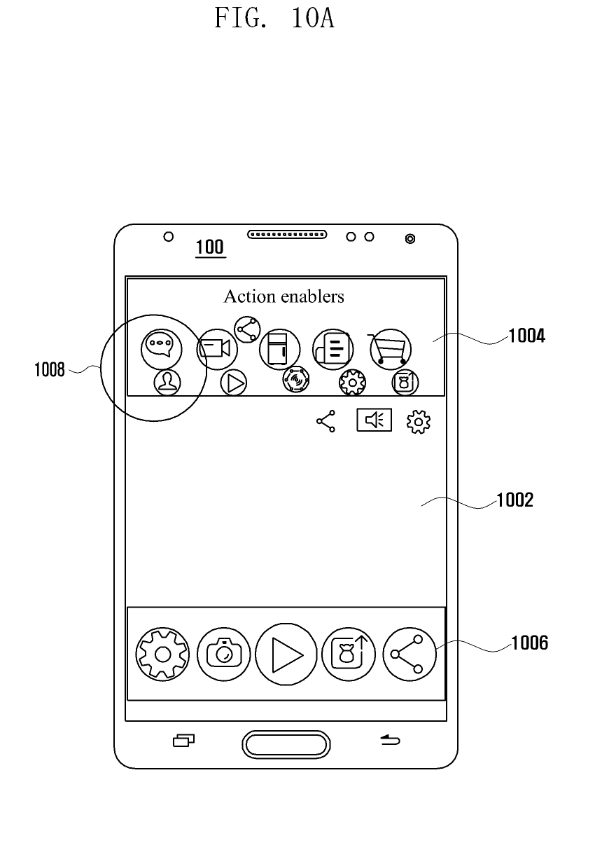

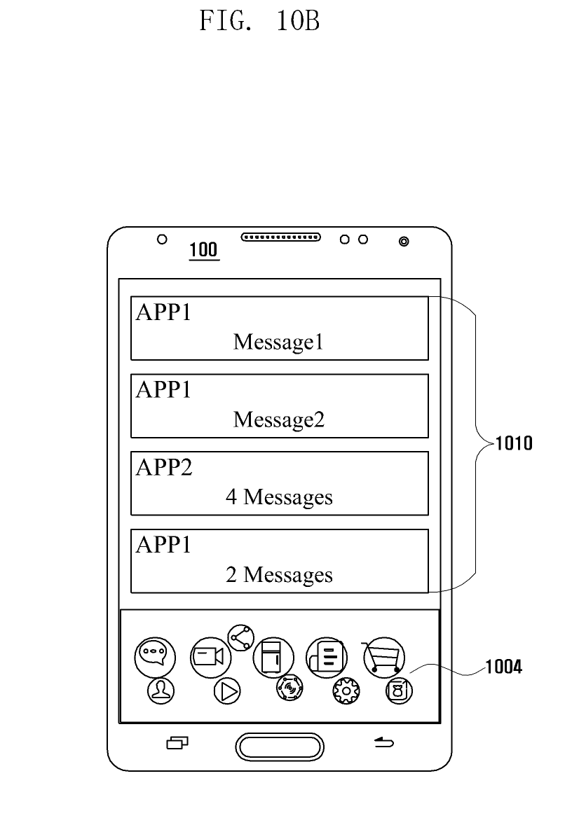

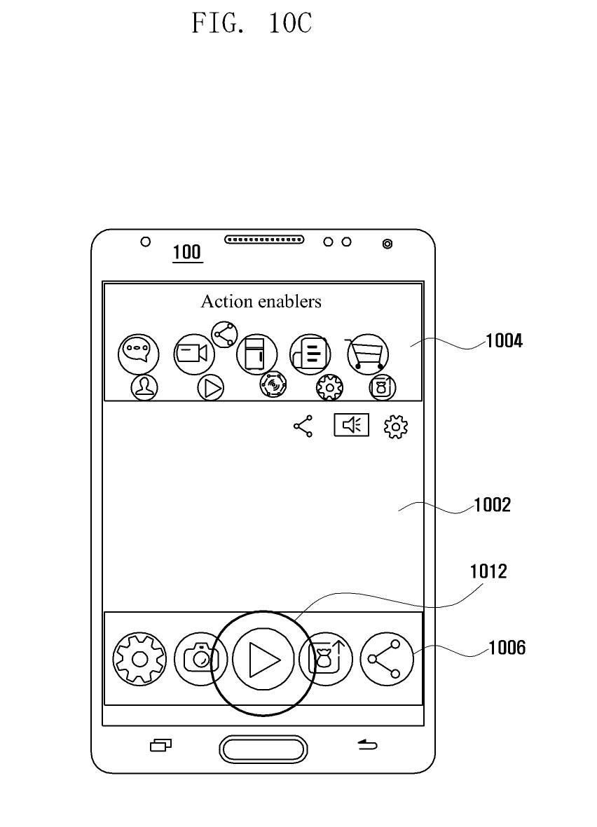

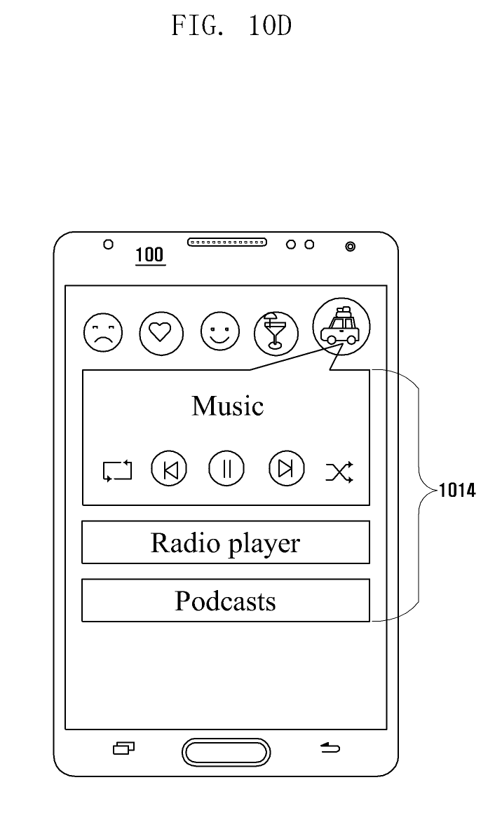

FIGS. 10A, 10B, 10C, and 10D is an example scenario illustrating the method of providing the functions on the user interface of a virtual assistant application 1002 based on the application notifications and suggestions provided by the virtual assistant, according to an embodiment of the disclosure.

Referring to FIGS. 10A, 10B, 10C and 10D, the electronic device 100 receives voice commands through the voice assistant application and determines the intent of the user based on the voice commands to perform the required actions.

Consider a scenario where the user of the electronic device 100 accesses the virtual assistant application 1002. A panel of enabler functions 1004 is provided at the top portion of the UI of the virtual assistant application 1002 and the set of functions 1006 associated with the context of the user is provided at the bottom portion of the UI of the virtual assistant application 1002, as shown in FIG. 10A. The enabler functions 1004 are the functions which require the immediate attention of the user and are determined based on the notifications. The set of functions 1006 are determined based on the context and the preferences of the user (i.e., user behavior).

The user selects the communication enabler function from the panel of enabler functions 1004 provided at the top portion of the UI of the virtual assistant application 1002 by providing the voice command (indicated by the circle 1008), as shown in FIG. 10A. In response to the user selecting the communication enabler function, the list of notifications 1010 associated with the communication enabler function is populated on the screen of the electronic device 100, as shown in FIG. 10B. Further, the panel of enabler functions 1004 is provided at the bottom of the UI which provides the list of notifications 1010.

Referring to the FIG. 10C, the user selects (by voice command 1012) the play music function from the panel of relevant functions 1006 provided at the bottom of the UI of the virtual assistant application 1002. In response to the user selecting the play music function, the electronic device 100 determines the context of the user as travelling and automatically plays the music from the play list associated with travelling without the user having to select the play list, as shown in FIG. 10D. Further, the play list can be one of predetermined by the user, based on users' choices, behavior, popularity and the like. Furthermore, the electronic device 100 displays the list of other music related applications for example a different music application, radio etc. 1014, as shown in FIG. 10D.

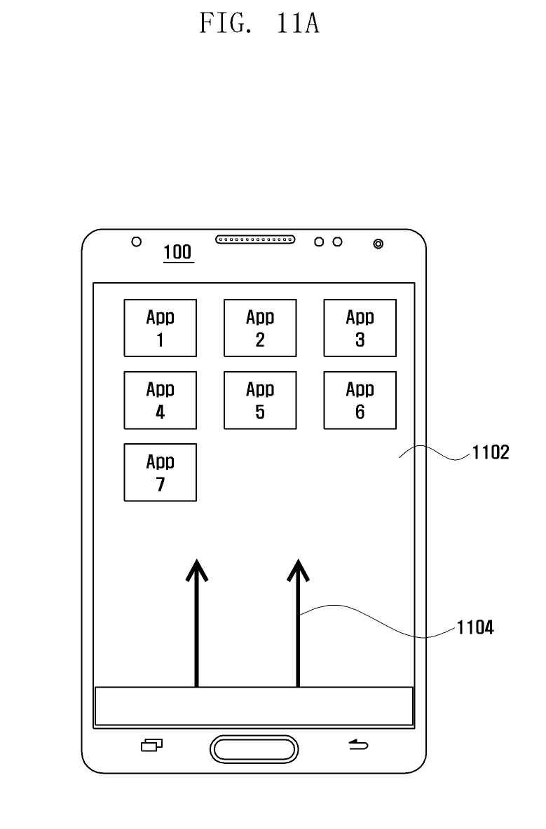

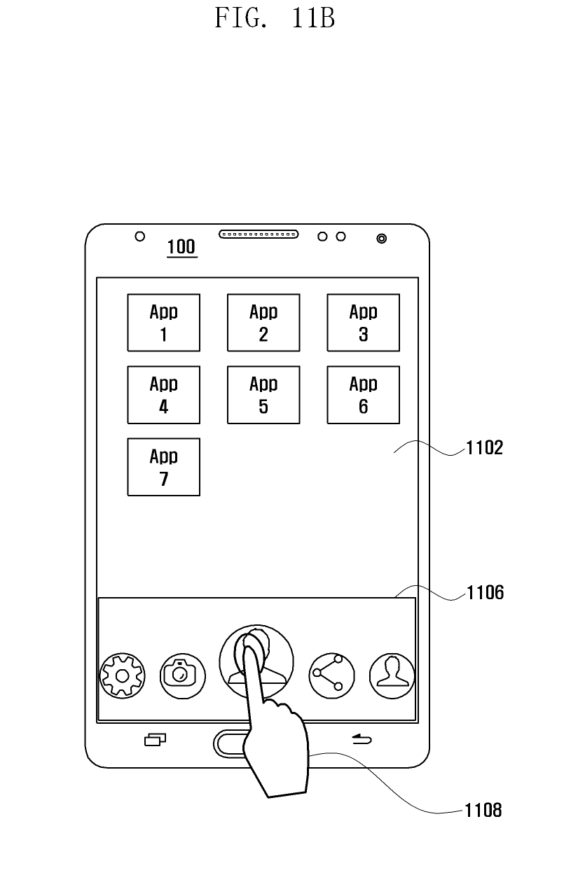

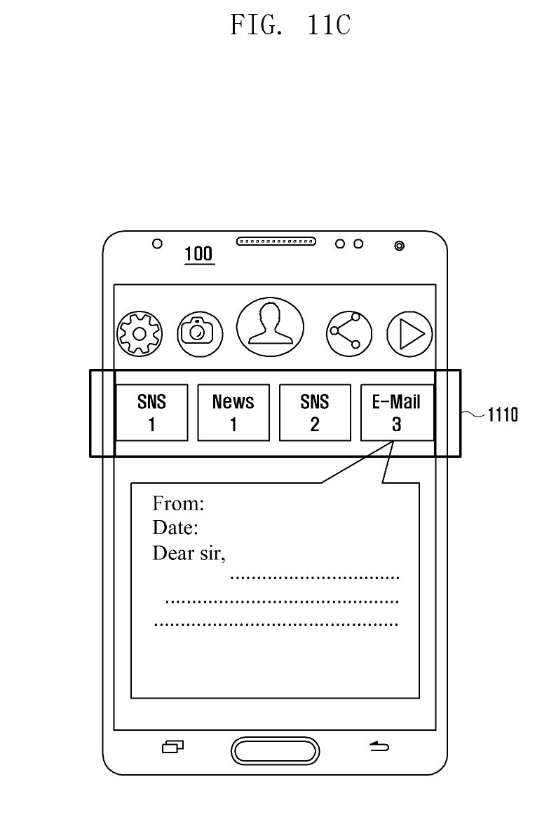

FIGS. 11A, 11B, and 11C is an example scenario illustrating the method of invoking the functions based on frequently used applications on the screen of the electronic device 100, according to an embodiment of the disclosure.

Referring to FIGS. 11A, 11B, and 11C, a scenario where the user frequently uses some applications such as e-mail application e-mail 3, SNS application SNS 1, SNS 2, and news application News 1. The frequently used applications are tracked by the context detection engine 120 and the context is determined based on the frequently used applications.

The user invokes the set of functions 1106 on the application menu screen of the electronic device 100 by performing a gesture 1104, as shown in FIG. 11A. The electronic device 100 determines the context of the user based on the frequently used applications of the user and provides the set of functions 1106 associated with the frequently used applications on the application menu screen 1102 of the electronic device 100, as shown in FIG. 11B. The set of functions 1106 associated with the frequently used applications can be for example contacts function if the user frequently accesses the email and SNS applications, share function if the user frequently shares pictures or links with the contacts, capture function if the user frequently accesses the camera and video recording applications, etc. Further, the user selects the contacts function from the set of functions 1106. On receiving the user input 1108, the electronic device 100 provides the list of relevant functions 1110 associated with the contacts function. The list of relevant functions 1110 can be applications such as email and SNS applications, as shown in FIG. 11C.

Furthermore, if the user frequently accesses the email-3 application to check for work related emails then the electronic device 100 will learn that the user frequently accesses the email-3 and provides higher priority to the email-3 application associated to the contact function, so that the email-3 application is automatically launched when the user selects the contact function.

Furthermore, the set of functions 1106 associated with the frequently used applications is provided on the screen of the electronic device 100 and the user can select any of the functions to perform a different function.

Various aspects of the disclosure can also be embodied as computer readable code on a non-transitory computer readable recording medium. A non-transitory computer readable recording medium is any data storage device that can store data which can be thereafter read by a computer system. Examples of the non-transitory computer readable recording medium include read-only memory (ROM), RAM, CD-ROMs, magnetic tapes, floppy disks, and optical data storage devices. The non-transitory computer readable recording medium can also be distributed over network coupled computer systems so that the computer readable code is stored and executed in a distributed fashion. Also, functional programs, code, and code segments for accomplishing the disclosure can be easily construed by programmers skilled in the art to which the disclosure pertains.

At this point it should be noted that various embodiments of the disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the disclosure as described above. Alternatively, one or more processors operating in accordance with stored instructions may implement the functions associated with the various embodiments of the disclosure as described above. If such is the case, it is within the scope of the disclosure that such instructions may be stored on one or more non-transitory processor readable mediums. Examples of the processor readable mediums include ROM, RAM, CD-ROMs, magnetic tapes, floppy disks, and optical data storage devices. The processor readable mediums can also be distributed over network coupled computer systems so that the instructions are stored and executed in a distributed fashion. Also, functional computer programs, instructions, and instruction segments for accomplishing the disclosure can be easily construed by programmers skilled in the art to which the disclosure pertains. Also, the embodiments disclosed herein may be implemented using at least one software program running on at least one hardware device and performing network management functions to control the elements.

While the has been shown and described with reference to various embodiments thereof, it will be understood by those skilled in the art that various changes in form and details may be made therein without departing from the spirit and scope of the disclosure as defined by the appended claims and their equivalents.

What is claimed:

1. An electronic device for enabling contextual interaction, the electronic device comprising:
a display;
a memory; and
a processor operatively connected to the display and the memory, wherein the processor is configured to:
detect a context indicative of user activities associated with the electronic device;
identify one or more functions from a pre-defined set of functions based on the detected context, wherein the pre-defined set of functions is grouped based on an index of the context;
control the display to display objects corresponding to each of the one or more functions, wherein the one or more functions are included in the pre-defined set of functions and are capable of executing at least one of applications or services for accessing content relevant to the context; and
in response to receiving a user input on one of the objects, execute a function corresponding to the inputted object.

2. The electronic device of claim 1, wherein the one or more functions are identified based on at least one of digital context associated with the user, physical context associated with the user, or user persona including usage pattern and a behavioral pattern of the user.

3. The electronic device of claim 2, wherein the digital context associated with the user is stored in a server remote from the electronic device.

4. The electronic device of claim 1, wherein each of the functions comprises a plurality of relevant functions associated with the function.

5. The electronic device of claim 4, wherein the plurality of relevant functions associated with the function is displayed along with the function for user interaction.

6. The electronic device of claim 1, wherein the executing of the function corresponding to the inputted object comprises:
determining a plurality of relevant functions associated with the function;
identifying a relevant function from the plurality of relevant functions using the detected context; and
performing the action based on the determined relevant function selected by the user.

7. The electronic device of claim 1, wherein the one or more functions are displayed distinctively based on the detected context for user interaction.

8. The electronic device of claim 1, wherein the one or more functions are automatically displayed on the display based on the detected context.

9. The electronic device of claim 1, wherein the one or more functions are displayed on the display for the detected context based on an input received from the user, wherein the input is one of a gesture input or a voice input.

10. The electronic device of claim 1, wherein the one or more functions and the plurality of relevant functions for the one or more functions are displayed on a pre-defined portion of the display.

11. The electronic device of claim 1, wherein the processor is further configured to:
detect whether at least one application is modified or installed on the electronic device;
in response to detecting that the application is modified or installed on the electronic device, identify a plurality of functions provided on the modified or installed application; and
modify the pre-defined set of functions by adding the identified plurality of function to the pre-defined set of functions.

12. A method for enabling contextual interaction on an electronic device, the method comprising:
detecting a context indicative of user activities associated with the electronic device;
identifying one or more functions from a pre-defined set of functions based on the detected context, wherein the pre-defined set of function is grouped based on an index of the context;
displaying objects corresponding to each of the one or more functions, wherein the one or more functions are included in the pre-defined set of functions and are capable of executing at least one of applications or services for accessing content relevant to the context; and
in response to receiving a user input on one of the objects, executing a function corresponding to the inputted object.

13. The method of claim 12, wherein the one or more functions are identified based on at least one of digital context associated with the user, physical context associated with the user, or user persona including usage pattern and a behavioral pattern of the user.

14. The method of claim 13, wherein the digital context associated with the user is stored in a server remote from the electronic device.

15. The method of claim 12, wherein each of the function comprises a plurality of relevant functions associated with the function.

16. The method of claim 15, wherein the plurality of relevant functions associated with the function is displayed along with the function for user interaction.

17. The method of claim 12, wherein the executing of the function corresponding to the inputted object comprises:
determining a plurality of relevant functions associated with the function;
identifying a relevant function from the plurality of relevant functions using the detected context; and
performing the action based on the determined relevant function selected by the user.

18. The method of claim 12, wherein the one or more functions are displayed distinctively based on the detected context for user interaction.

19. The method of claim 12, wherein the one or more functions are automatically displayed on a display of the electronic device based on the detected context.

20. An electronic device for enabling contextual interaction, the electronic device comprising:
a display;
a memory; and
at least one processor operatively connected to the display and the memory, wherein the at least one processor is configured to:
control the display to display at least one object corresponding to at least one function, wherein the at least one function is included in a pre-defined set of functions which is grouped based on an index of context and each of the at least one function is capable of being executed in one or more applications;
receive a user input on one of the at least one object;
detect a context including at least one of user activity associated with the electronic device, capability or status of the electronic device;
identify one or more applications capable of executing a function corresponding to the one of the at least one object on which the user input is received; and
perform one of executing the function in an application selected among the one or more applications based on the context, and suggesting at least one application among the one or more applications based on the context.
